(19) United States
(12) Patent Application Publication
(10) Pub. No.: US 2019/0016271 A1
(43) Pub. Date: Jan. 17, 2019

(54) RECREATIONAL EQUIPMENT RACK

(71) Applicant: NORCO INDUSTRIES, INC., Compton, CA (US)

(72) Inventor: Bernard F. GARCEAU, Vandalia, MI (US)

(21) Appl. No.: 16/033,947

(22) Filed: Jul. 12, 2018

Related U.S. Application Data
(60) Provisional application No. 62/607,716, filed on Dec. 19, 2017.
(60) Provisional application No. 62/531,647, filed on Jul. 12, 2017.

(51) Int. Cl. B60R 9/10; B60R 9/06

(52) U.S. Cl. CPC B60R 9/10; B60R 9/06

(57) ABSTRACT

Disclosed are vehicle-mounted equipment racks capable of securing one or more articles of recreational equipment, such as bicycles and/or kayaks. When utilized to store bicycles, the equipment rack stores the bicycles in a vertical orientation, thereby providing the vehicle to which the equipment mount is installed to have maximum overhead clearance and, as compared to vehicle-mounted equipment racks storing bicycles in horizontal orientations, permit storage of bicycles with less “overhang” and are subject to less torque load. In one embodiment, the equipment rack comprises at least one substantially vertical member having a top end and a bottom end, a wheel hook disposed at the top end, a wheel support member disposed at the bottom end, and a mounting portion disposed at the bottom end and adapted to attach to a frame of the trailer.

### CROSS-REFERENCE TO RELATED APPLICATIONS

This application claims benefit of U.S. Provisional Application No. 62/531,647, filed Jul. 12, 2017, the disclosure of which is incorporated by reference in its entirety, and this application claims benefit to U.S. Provisional Application No. 62/607,716, filed Dec. 19, 2017, the disclosure of which is incorporated by reference in its entirety.

### BACKGROUND

Outdoor sports such as cycling and kayaking have dramatically grown in popularity over the years and have therefore created a substantial market for vehicle-mounted equipment racks. A variety of vehicle-mounted equipment racks are commercially available, such as top-mounted equipment racks and rear-mounted equipment racks. Such equipment racks may be configured to store various types of outdoor equipment such as bicycles, kayaks, canoes, various types of boards, skis, etc. Top-mounted equipment racks, however, are often hard to utilize, especially when attempting to mount thereto equipment like bicycles on top of taller vehicles like sport utility vehicles, pick-up trucks, recreational vehicles, etc. Indeed, certain trailer hitch equipment racks are also difficult to utilize for the same reasons. Moreover, using top-mounted equipment racks on such taller vehicles reduces overhead clearance, which could result in damage to the bicycle and/or vehicle if driven underneath an object without sufficient clearance. Rear-mounted equipment racks, while being easier to access, are not adapted to mount to all types of vehicles and in some instances may inhibit and/or obstruct utilization of the vehicle's trunk compartment.

Many commercially available vehicle mounted equipment racks carry bicycles in horizontal orientations, meaning both the front and rear wheels are horizontally aligned with each other. This horizontal orientation, however, limits the number of bikes that may be carried by vehicle-mounted equipment racks because each bike increases the length of the vehicle. This is especially true with regard to cantilevered vehicle equipment racks that laterally extend from a side of the vehicle like some commercially available rear-mounted bicycle racks, and these cantilevered vehicle equipment racks are subjected to increased torques when horizontally mounted bicycles are progressively installed thereon as compared to equipment racks configured to store bicycles in vertical orientations.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a top right view of one embodiment of a vehicle-mounted equipment rack configured to hold a pair of bicycles, according to one or more embodiments.

FIG. 2 is a right side view of the equipment rack of FIG. 1, where the bicycles are stored at different vertical orientations relative to each other.

FIG. 3A is a right side view of an equipment rack in a retracted configuration and configured to store at least a pair of pieces of recreational equipment but without out such pieces of recreational equipment secured thereon, according to one or more embodiments.

FIG. 3B is a right side view of the equipment rack of FIG. 3A when extended to secure at least a pair of recreational equipment at different vertical orientations.

FIG. 4A is an isometric view of the equipment rack of FIG. 3A.

FIG. 4B is an isometric view of the equipment rack of FIG. 3B.

FIG. 5 is an isometric view of the equipment rack of FIG. 4B.

FIG. 6 is a top left view of an alternate equipment rack according to one or more other embodiments.

FIG. 7 is a top view of the equipment rack of FIG. 6.

FIG. 8 is a top right view of another alternate equipment rack according one or more other embodiments.

FIG. 9A is an isometric view of the equipment rack of FIG. 8 when retracted, but without pieces of recreational equipment secured thereon.

FIG. 9B is an isometric view of the equipment rack of FIG. 8 when extended, but without pieces of recreational equipment secured thereon.

FIG. 10A is a right isometric view of the equipment rack of FIG. 8 when retracted and when installed on a trailer, but without pieces of recreational equipment secured thereon.

FIG. 10B is a right isometric view of the equipment rack of FIG. 8 when extended and when installed on a trailer, but without pieces of recreational equipment secured thereon.

FIG. 11 illustrates an alternate embodiment of a vehicle-mounted equipment rack.

FIGS. 12A-12C illustrates views of the vehicle-mounted equipment rack of FIG. 11.

FIGS. 13A-13B illustrate an alternate embodiment of a vehicle mounted equipment rack that includes a pair of the vehicle mounted equipment racks of FIG. 11 installed on opposing sides of a trailer frame.

FIGS. 14A-14B illustrate an alternate embodiment of an equipment rack configured to store one or more kayaks or other vessels wherein the equipment rack is in the stowed position.

FIGS. 15A-15B illustrate the equipment rack of FIGS. 14A-14B having a pair of rack structures, wherein an equipment bed of one of the rack structures is rotated into a lowered position and the other rack structure is rotated into an up-right position.

### DETAILED DESCRIPTION

This patent describes a vehicle-mounted equipment rack capable of securing one or more articles of recreational equipment (e.g., bicycles, canoes, kayaks, paddle boards, surfboards, etc.) in substantially vertical orientations. Such vehicle-mounted equipment racks provide vehicles maximum overhead clearance as opposed to overhead-mounted equipment racks and, as compared to vehicle rear-mounted equipment racks that, for example, store bicycles in horizontal orientations, permit storage of bicycles with less “overhang” and are subject to less torque load. In addition, such vehicle-mounted equipment racks permit users to more easily access the recreational equipment when installed at a front end of a recreational vehicle such as a fifth wheel, travel trailer, etc., as compared to commercially available recreational vehicle equipment mounts.

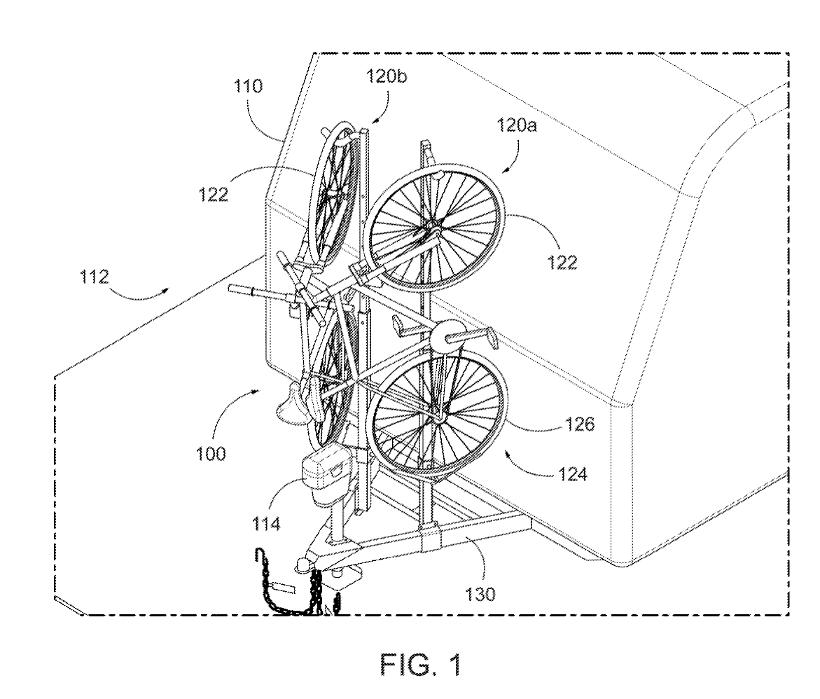

FIG. 1 is a top right view of a vehicle-mounted equipment rack 100 installed on a trailer 110 according to one or more embodiments. The trailer 110 may be various types of vehicles, for example, a travel trailer, a recreation vehicle, a utility trailer, a fifth wheel, etc. However, while the figures may illustrate the trailer 110 as a travel trailer and while the trailer 110 is sometimes referred to herein as the travel trailer 110, it will be appreciated that the trailer 110 may be any type of vehicle without departing form the present disclosure. As illustrated, the equipment rack 100 is illustrated to secure a pair of bicycles 120a,b and thus includes two vertical rack components, for example, a right rack structure 102a and a left rack structure 102b, with the right rack structure 102a securing the right bicycle 120a and the left rack structure 102b securing the left bicycle 120b. In other non-illustrated embodiments, however, the equipment rack 100 includes more than two vertical rack structures or less than two vertical rack structures, such that more or less than two bicycles 120a,b (and/or other recreational equipment) may be secured. The various components of the equipment rack 100 may be made of any rigid or semi-rigid material, such as a metal or a plastic.

The equipment rack 100 is configured to secure various types and/or pieces of recreational equipment. In the illustrated embodiment of FIG. 1, for example, the equipment rack 100 is configured to secure and store two bicycles 120a,b; however, in other embodiments, it may be configured to secure and store more or less than two bicycles, as well as other recreational equipment such as canoes, kayaks, boards, skis, etc. In even other embodiments, the equipment rack 100 may be configured to store multiple pieces of recreational equipment of different types, for example, one or more bicycles as well as one or more kayaks, canoes, or paddle boards.

In the illustrated embodiment, the equipment rack 100 is installed on an A-frame 130 that extends from a front side 112 of the travel trailer 110 at a location just behind the control box 114. It may be differently secured to other structures of the travel trailer 110, however, at the same or different sides of the travel trailer 110. Mounting at this location just behind the control box 114 permits the equipment rack 100 to be mounted directly to the base or frame of the travel trailer (e.g., on the A-frame 130) rather than at a location having a higher elevation (e.g., above the control box 114) and also facilitates installation or removal of the bicycles 120a,b or other equipment onto the equipment rack 100. In other embodiments, one or more equipment racks 100, whether each having more or less than a pair of rack structures 102a,b, may be mounted to the rear side of the travel trailer 110 and/or either or both lateral sides of the travel trailer 110, in addition to or instead of the front side 112 of the travel trailer 110.

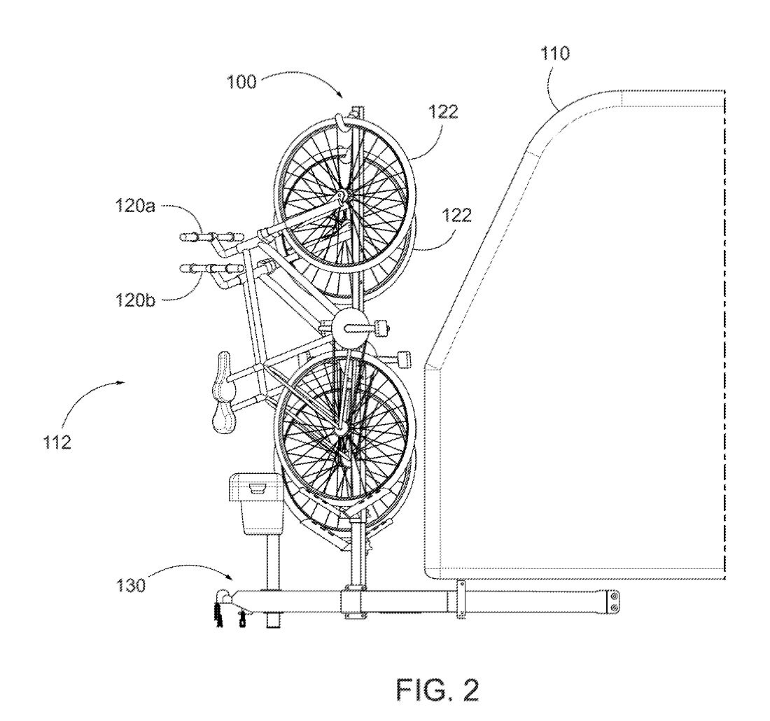

FIG. 2 is a right side view of the equipment rack 100 of FIG. 1. This figure further illustrates the manner in which each vertical structure of the equipment rack 100 may be vertically mounted on the cantilevered A-frame 130 that laterally extends from the front side 112 of the travel trailer 110. Here, the equipment rack 100 as illustrated, however, utilizes preexisting frame members to mount the equipment rack 100 and further secures the bicycles 120a,b at a location between the travel trailer 110 and the tow vehicle (not illustrated). This mounting configuration results in less “overhang” as compared to a rear-mounted bicycle rack that would effectively increase the length of the vehicle and, moreover, maintains the bicycles 120a,b at a location where they will not be damaged in the event that the travel trailer 110 is rear-ended by a trailing vehicle. FIG. 2 also shows how pieces of recreational equipment secured thereon (here, for example, the bicycles 120a,b) may be stowed vertically off-set relative to each other; though the recreational equipment need not be off-set relative to each other. This off-set mounting of recreational equipment may be useful to accommodate different size recreational equipment (e.g., where the first bicycle 120a is larger than the second bicycle 12b), useful to accommodate different types of recreational equipment (e.g., two bicycles 120a,b plus one or more kayaks), or useful to accommodate other equipment (not illustrated) attached to the A-frame 130 such as a cooler, tool box, or other container, etc.

As mentioned, above, however, the equipment rack 100 may be installed at one or more other sides (lateral and/or rear) of the travel trailer 110 in addition to or in lieu of the front side 112. For example, the equipment rack 100 may instead (or in addition to) be installed on a rear side (not illustrated) of travel trailer 110 via a rear cantilever (not illustrated) laterally extending therefrom or may be wall mounted to the rear wall of the travel trailer 110. In even other embodiments, one or more of the equipment racks 100 may be installed on the roof or other upper surface of the travel trailer 110, which may, for example, be desirable where multiple pieces of equipment are being transported. Also, the equipment rack 100 of FIG. 2 includes a pair of rack structures 102a,b that each secure one of the bicycles 120a,b, but in other embodiments, the equipment rack 100 may include only one such rack structure so that only one of the bicycles 120a,b is secured or more than two rack structures so that more than two bicycles (not illustrated) may be stored; and, where multiple equipment racks 100 are utilized, each of them may have any number of rack structures depending on the number of equipment or bicycles to be transported.

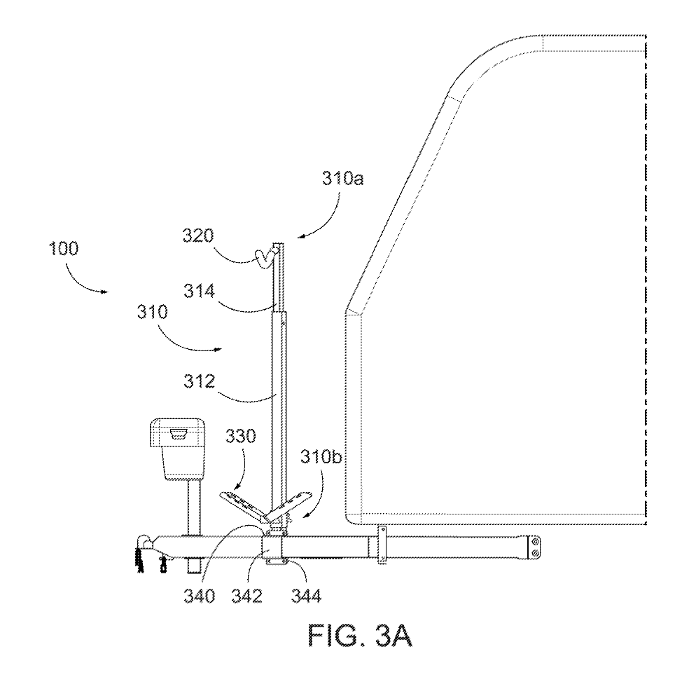

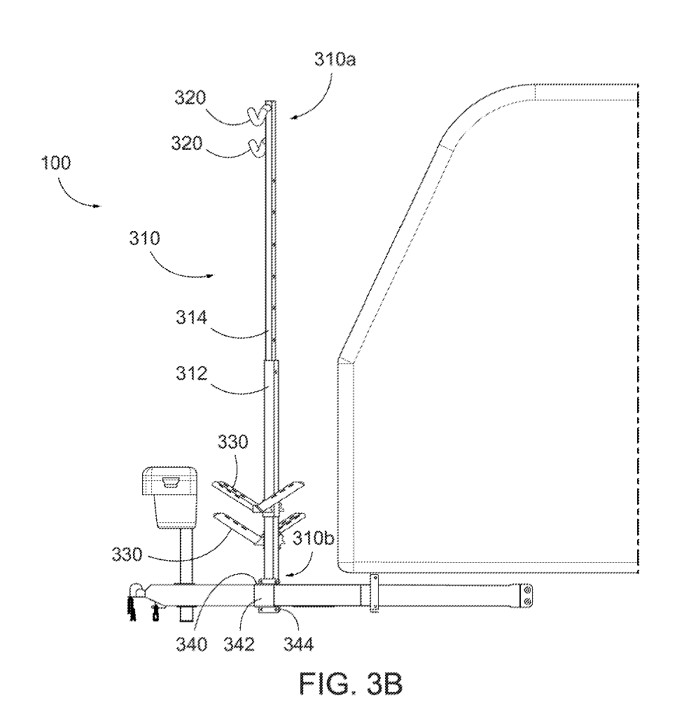

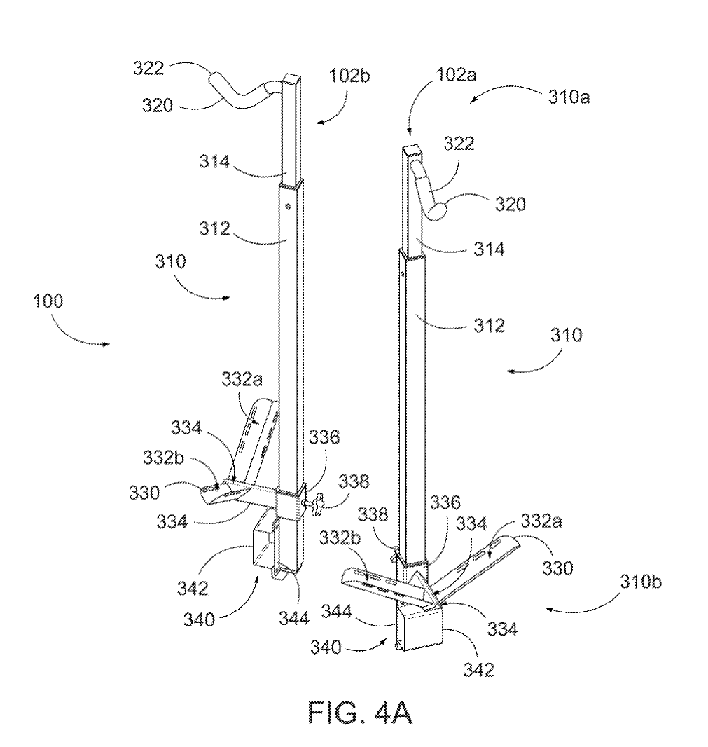

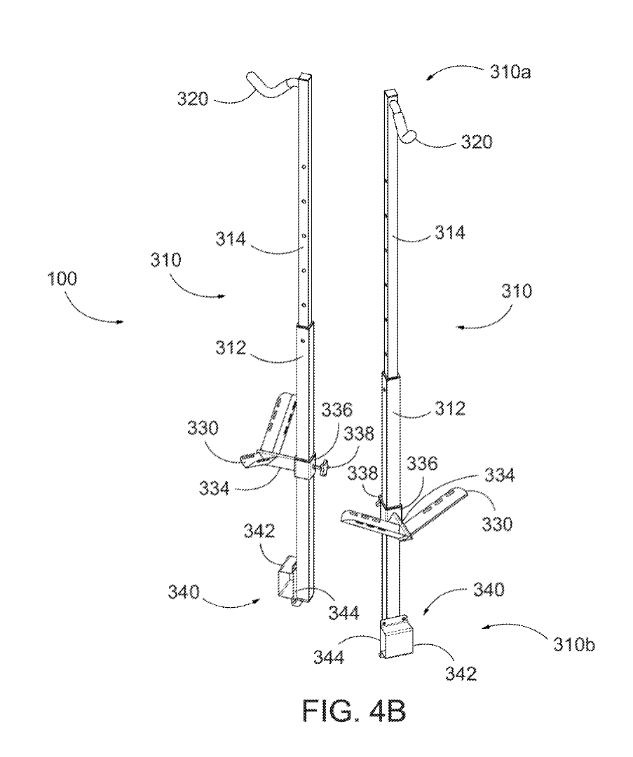

FIGS. 3A and 3B are right side views of the equipment rack 100 having a pair of rack structures 102a,b without equipment installed therein when in the retracted and extended positions, respectively, according to one or more embodiments. FIG. 4A is an isometric side view of the equipment rack 100 of FIG. 3A and FIG. 4B is an isometric side view of the equipment rack 100 of FIG. 3B. As illustrated, the equipment rack 100 may be configured to telescope or extend so that it may accommodate equipment of different sizes and to orient the equipment relative to each other to inhibit interference between the same. In the illustrated embodiment, each rack structure of the equipment rack 100 includes at least one vertical shaft 310 that “telescopes” and includes a top end 310a and a bottom end 310b. Here, the equipment rack 100 comprises two shafts 310, with each of the shafts 310 corresponding to one of the pair of rack structures 102a,b. In other embodiments where the equipment rack 100 includes a single rack structure, such equipment rack 100 may include a single shaft 310, whereas in even other embodiments of the equipment rack 100 having more than two rack structures 102a,b, the equipment rack 100 may include more than two shafts 310.

The equipment rack 100 is configured to secure recreational equipment and, in the illustrated embodiment, the equipment rack 100 is configured to secure recreational equipment in a vertical orientation. Thus, each rack structure of the equipment rack 100 is configured to secure a top of the recreational equipment as well as a bottom of the recreational equipment. In the illustrated embodiment, the equipment rack 100 comprises a hook 320 disposed at the top end 310a of the shaft 310 and a support member 330 disposed at the bottom end 310b of the shaft 310. The hook 320 and the support member 330 are configured to secure the piece of recreational equipment, such as a bicycle, in a vertical orientation as hereinafter described. It should be appreciated, however, that while the equipment racks disclosed herein are described as including a hook at the upper end for securing an upper wheel, they may instead include a clamp or any other type of wheel securing means as known in the art without departing from the present disclosure. It should also be appreciated, that while the equipment racks disclosed herein are described as including a support member at the lower end for securing a lower wheel, they may instead include a clamp or any other type of wheel securing means as known in the art without departing from the present disclosure.

As mentioned above, the equipment rack 100 is also configured to be mounted to a travel trailer 110. Accordingly, in the illustrated embodiment, the equipment rack 100 may include a mounting portion 340 disposed at the bottom end 310b of the shaft 310 that is arranged to attach the one or more rack structures 102a,b of the equipment rack 100 to the travel trailer 110, for example, at the A-frame 130 of the travel trailer 110. As illustrated, the mounting portion 340 may comprise a bracket 342 and a mounting plate 344 that are configured to mount on the travel trailer 110. For example, the mounting plate 344 and the bracket 342 may be configured to clamp onto and sandwich a portion of the A-frame 130. It will be appreciated, however, that the mounting portion 340 may be differently configured to attach the equipment rack 100 to the travel trailer 110, such as being welded, being secured via a fastener (e.g., a screw), being strapped, being secured with a friction lock assembly, being secured via a clamp, being secured via magnets, or combinations of the same. In some unillustrated embodiments, the trailer frame may be formed with inserts for receiving the mounting portion 340. For example, the mounting portion 340 may be a male key shaft (e.g., different than as illustrated with the bracket and mounting plate 340) that is specially designed to be received with a specially designed mating key hole (or other cavity, slot or recess) formed in the A-frame 130.

As previously mentioned, any of the shafts 310 may be configured to extend and “telescope.” In the illustrated embodiment, each of the shafts 310 includes a sleeve portion or sleeve 312 and a telescoping portion 314, where the telescoping portion slides within and relative to the sleeve 312 such that it may extend from and retract into the sleeve 312. In other non-illustrated embodiments, not all of the shafts 310 are configured to telescope, or in even other non-illustrated embodiments utilizing more than two shafts 310, all or only some of the shafts 310 may be configured to “telescope.”

In addition, various locking mechanisms may be utilized to lock the telescoping portion 314 relative to the sleeve 312 such that the shaft 310 is extended or retracted into the desired length. In the illustrated embodiment, telescoping portion 314 includes a spring-loaded pin that is configured to permit a user to selectively engage one of a plurality of holes formed into the sleeve 312. It will be appreciated, however, that other locking mechanisms may be utilized. For example, a threaded fastener, a collet lock, a clamp, a fiction lock, a pawl and detent, or combinations of the same, may be utilized to selectively lock the telescoping portion 314 relative to the sleeve 312.

In the illustrated embodiment, the hook 320 is configured to hold a front wheel 122 or a rear wheel 124 of either of the bicycles 120a. Here, the hook 320 is disposed on the telescoping portion 314 proximate to the top end 310a and, in the illustrated embodiment, the hook 320 secures the front wheel 122 of bicycles 120a,b. However, either or both of the bicycles 120a,b could be rotated so that the hook 320 instead secures the rear wheel 124. Also in the illustrated embodiment, the hook 320 includes a sock or protective sleeve 322 that is made from a compliant material that protects the rim of the wheel 122. The protective sleeve 322 may be made of an elastic or pliable material, and suitable elastic or pliable materials include, but are not limited to, plastic, rubber (e.g., natural rubber, synthetic rubber, nitrile rubber, silicone rubber, a urethane rubber, a polyether rubber, chloroprene rubber, ethylene propylene diene monomer, styrene-butadiene rubber, etc.), silicone, ethylene vinyl acetate, nylon, vinyl, spandex, polyurethane, polyethylene, polypropylene, polyisoprene, or any combination thereof.

The support member 330 is disposed proximate to the bottom end 310 b of the shaft 310 and, in embodiments where the equipment rack 100 secures at least one bicycle 120a,b, the support member 330 may be configured to receive a front or rear wheel 122,124. In the illustrated embodiment, the support member 330 is attached to the sleeve 312 proximate to the bottom end 310b and comprises a pair of upwardly angled members 332a,b. Also in the illustrated embodiment, the members 332a,b are configured with channels that define a trough 334 to receive the front and/or rear wheel 122,124, and are thus sometimes referred to as the channel members, wheel channels, or channels 332a,b; however, in other embodiments, the members 332a,b are not channeled, but instead flat or of other geometries. Also in the illustrated embodiment, the members 332a,b laterally extend from the sleeve 312 and are configured in a “V” shaped geometry to receive a tire 126 of the rear wheel 124. The “V” shaped geometry allows the rear wheel 124 to rest at the trough 334 of the support member 330 such that the rear wheel 124 is inhibited from rolling therein. In other embodiments, however, the support member 330 comprises a horizontally disposed member (configured with or without a channel) to receive the tire 126 rather than a “V” shaped geometry; and such horizontally disposed channel may include therein one or more barriers or braces that inhibit the rear wheel 124 from rolling therein. It will be appreciated, however, that the support member 330 may comprise different geometries, and in at least some embodiments, may include a circular or semi-circular geometry that is shaped similar to rear wheel 124. In even other embodiments, the support member 330 is a clamp that grasps the rear or front wheel 122,124 or other portion of the bicycle frame.

In the illustrated embodiment, the support member 330 laterally extends from the sleeve 312 at a location directly beneath the hook 320 so that when secured, the front wheel 122 and the rear wheel 124 are vertically aligned. In other embodiments, however, the support member 330 is laterally offset from the hook 320 so that the equipment secured therein angled when stowed within the rack structure of the equipment rack 100. In the illustrated embodiment, the support member 330 is interconnected to the sleeve 312 via a lateral frame member 334 and attachment member 336. In at least some embodiments, the attachment member 336 is an outer sleeve that is configured to slide up and down along (and relative to) the sleeve 312 and to be selectively locked thereto via a fastener 338.

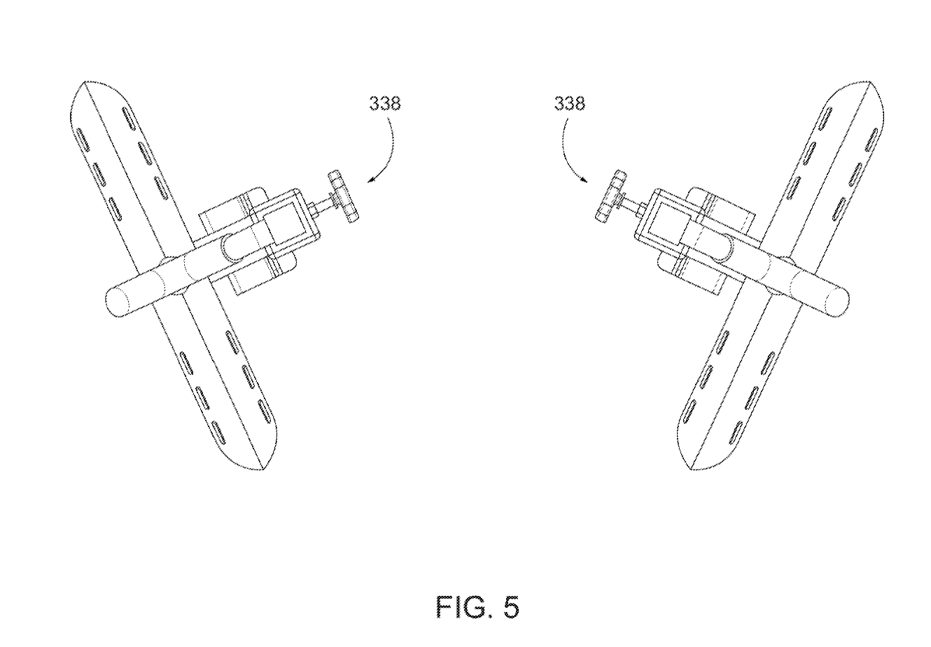

FIG. 5 is a top view of the equipment rack 100 of FIG. 4B, and illustrates the fastener 338 according to one or more embodiments. In the illustrated embodiment, the fastener 338 comprises a threaded fastener (not illustrated) with a star knob affixed thereto. It will be appreciated, however, that other locking mechanisms or fasteners may be utilized, for example, those mentioned above for locking the telescoping portion 314 relative to the sleeve 312.

Accordingly, the equipment rack of this embodiment may be adapted to receive bicycles of different sizes by extending or retracting the telescoping portion 314 with the hook 320 from or into the sleeve 312 and/or sliding the wheel support member 330 up or down along the sleeve 312. Accordingly, bicycles 120a,b may be secured at different vertical orientations relative to the shafts 310. For example, where the equipment rack 100 includes a pair of rack structures 102a,b that each include the shaft 310 to secure one of the two bicycles 120a,b, the hook 320 and the wheel support member 330 of the first shaft 310 may telescope to be upwardly offset relative to the hook 320 and the wheel support member 330 of the second shaft 310 that may or may not be telescoping. It will be appreciated that this configuration ensures that each of the bicycles 120a,b is properly secured in an vertical orientation, and that their laterally extending handle bars 122 or other components do not interfere with one another which may otherwise inhibit either or both of the rear wheels 124 from being fully seated within the respective wheel support member 330.

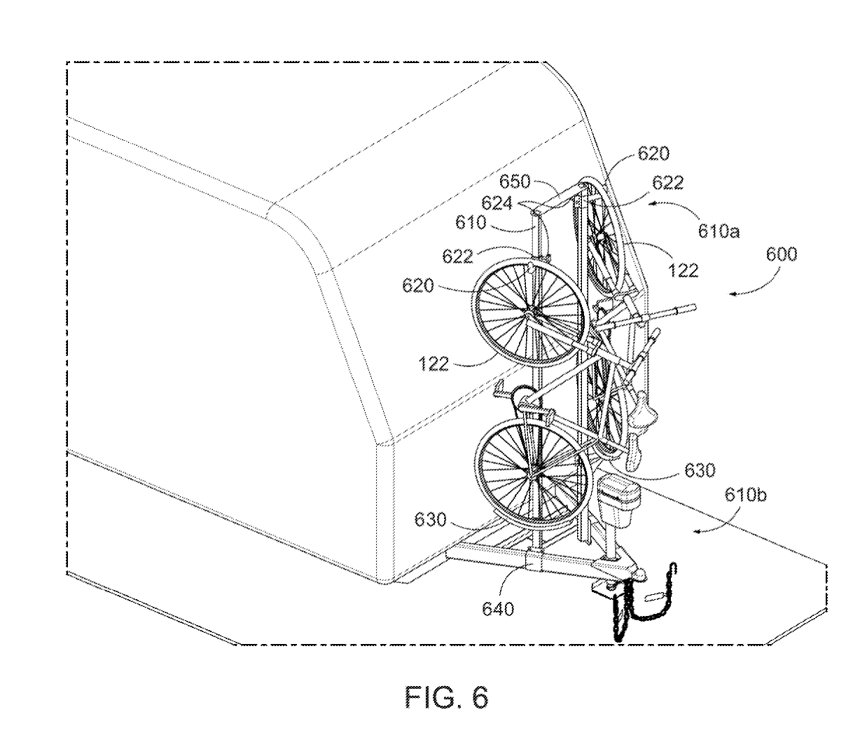

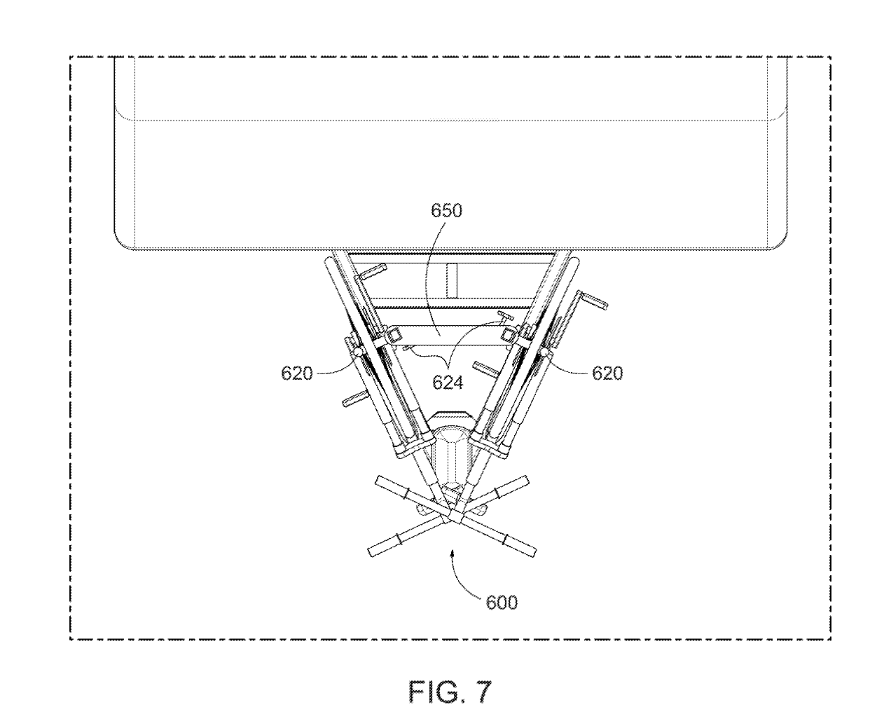

FIGS. 6-7 illustrate an alternate embodiment of an equipment rack 600 according to one or more embodiments. As illustrated in the top left view of FIG. 6 and the top view of FIG. 7, the equipment rack 600 includes at least one vertical shaft 610 that may or may not be configured to telescope as discussed above, and each of the shafts 610 further includes a hook 620 disposed at a top end 610a of the shaft 610, a support member 630 disposed at a bottom end 610b of the shaft 610, and a mounting portion 640 also disposed at the bottom end 610b of the shaft 610. Here, the equipment rack 600 includes two such vertical shafts 610 that are interconnected at their top ends 610a via a brace or cross-bar 650.

This embodiment of the equipment rack 600 is similar to the embodiment illustrated in FIGS. 1-5, except that the vertical shafts 610 need not “telescope” like the shafts 310 illustrated in FIGS. 1-4. Instead, the hooks 620 are configured to vertically translate along and relative to the vertical shafts 610. Accordingly, the hooks 620 may be interconnected to their respective shaft 610 via a sleeve 622 that is configured to vertically translate relative to the shaft 610 so that the user may adjust the height at which the forward wheel 122 is set. And, similar to the hook 320 detailed above, the hooks 620 may include a protective sleeve (not illustrated) similar to the protective sleeve 322. Accordingly, the protective sleeve may be made of the same materials identified with respect to the protective sleeve 322. Moreover, the sleeve 622 may include a locking mechanism or fastener 624 so that the user may secure the sleeve 622 in a desired position. In the illustrated embodiment, the fastener 624 is a threaded fastener (not illustrated) with a star knob affixed thereto; though, it will be appreciated, however, that other locking mechanisms or fasteners may be utilized, for example, those mentioned above for locking the telescoping portion 314 relative to the sleeve 312. In other non-illustrated embodiments, the shafts 610 may be configured as telescoping shafts in addition to including the hooks 620 and the sleeve 622.

Similarly, the support member 630 may be similarly configured as the support member 330, and the mounting portion 640 may be similarly configured as the mounting portion 340. Thus, the support member 630 may vertically translate along the shaft 610 such that it may secure equipment of different sizes in a similar manner as the hook 620 and the sleeve 622 corresponding therewith as discussed above. Moreover, the equipment rack 600 according to this alternate embodiment is similarly configured to store the bicycle 120a in a vertically offset position relative to bicycle 120b. This configuration ensures that each of the bicycles 120a,b is properly secured in an vertical orientation, and that their laterally extending handle bars 122 do not interfere with one another that may otherwise inhibit either or both of the rear wheels 124 from being fully seated within the respective wheel support member 630.

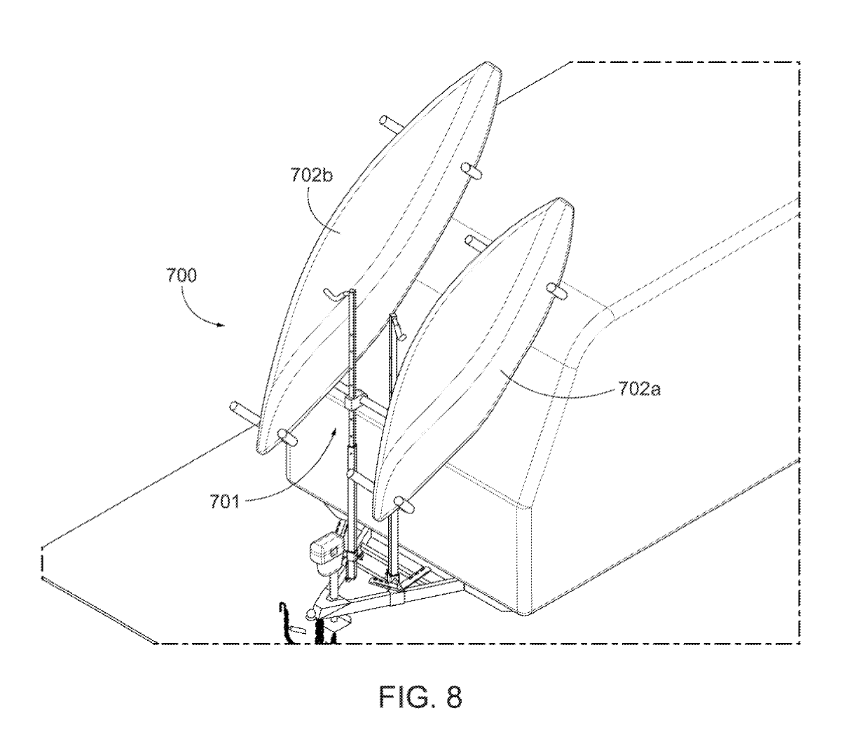

FIGS. 8-10 illustrate an exemplary equipment rack 700, according to one or more embodiments. Here, the equipment rack 700 is similarly configured to the equipment rack 100 of FIGS. 1-5 in some regards, but is further configured to receive additional recreational equipment such as canoes, kayaks, and various types of boards, skis, etc. Because the equipment rack 700 may be similar to the equipment rack 100 of FIGS. 1-5, like components will not be further described; however, the equipment rack 700 may include additional set of components that permit it to carry certain recreation equipment as hereinafter described.

FIG. 8 is a top right view of the equipment rack 700 that includes a vessel assembly 701 that is configured to receive a pair of kayaks 702a,b, according to one or more embodiments. The vessel assembly 701 of the equipment rack 700 may be configured to receive various sized vessels, such as the kayaks 702a,b that have different lengths. In the illustrated example, both the equipment rack 700 and the vessel assembly 701 thereof are capable of “telescoping” between a retracted and extended position, which facilitates receiving different sized vessels such as the kayaks 702a,b. Those skilled in the art will appreciate, however, that the equipment rack 700 and/or the vessel assembly 701 thereof may be utilized to carry and secure other vessels of various sizes such as canoes, rafts, skis, and various types of boards, etc.

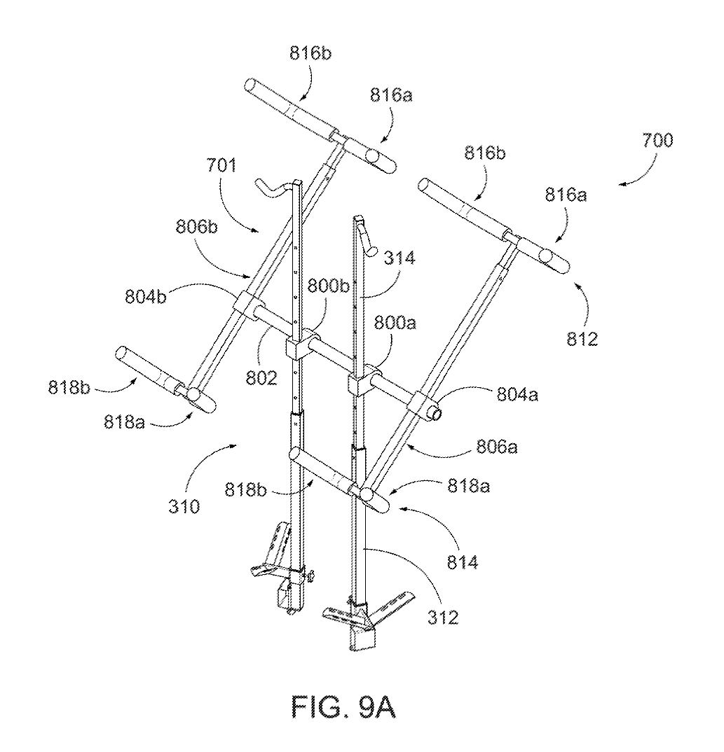

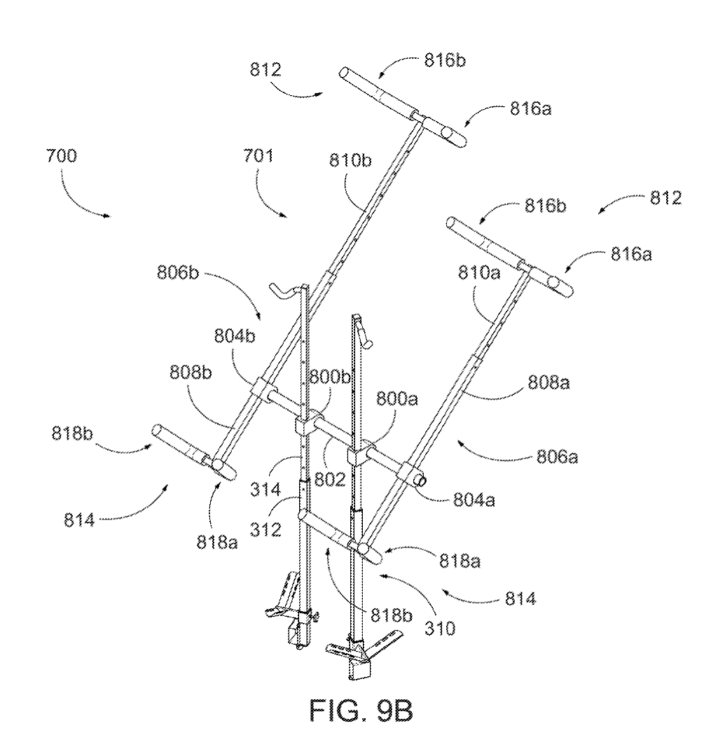

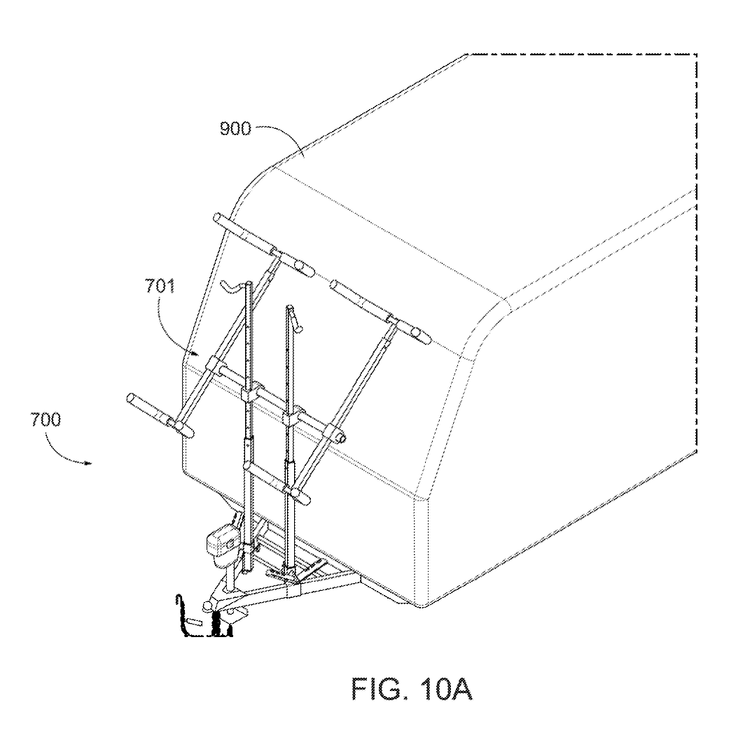

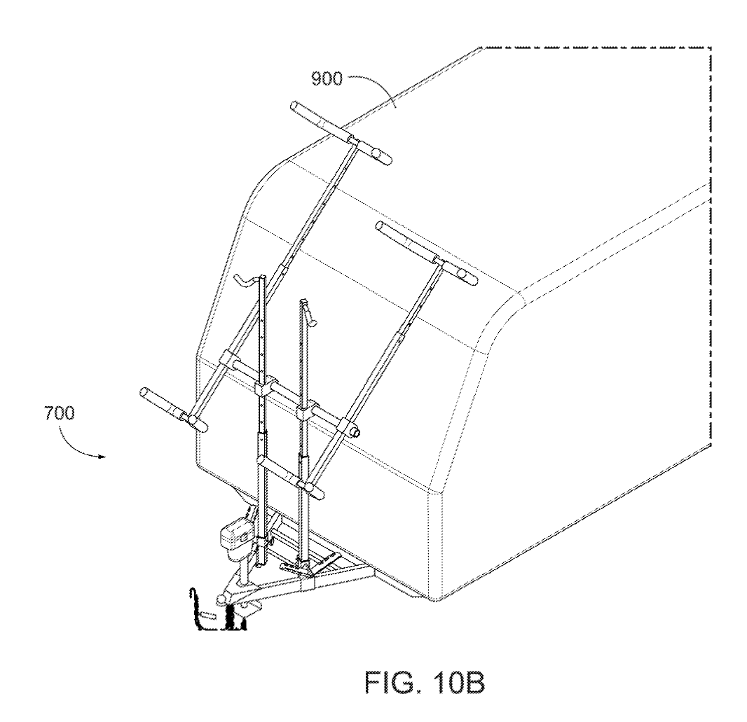

FIGS. 9A and 9B illustrate isometric side views of the equipment rack 700 of FIG. 8 when not installed on a vehicle and when in retracted and extended orientation, respectively. FIGS. 10A and 10B are isometric side views of the equipment rack 700 of FIGS. 9A and 9B, respectively, when installed on a vehicle such as a travel trailer 900. As illustrated, the vessel assembly 701 of the equipment rack 700 further includes a pair of trunnions 800a,b adapted to slideably engage vertical shafts 310, for example, at telescoping portion 314 as illustrated. The pair of trunnions 800a,b may be secured at various vertical orientations relative to the vertical shafts 310 and/or the telescoping portions 314. In some embodiments, the trunnions 800a,b may be disposed on the sleeves 312. In addition, the pair of trunnions 800a,b may be locked thereto via a locking mechanism such as a spring loaded pin that is configured to permit a user to selectively engage one of a plurality of holes formed into the sleeve 312. It will be appreciated, however, that other locking mechanisms may be utilized, for example, a friction lock system or a pawl and detent system, or other types of locking mechanisms as disclosed herein.

Each of the pair of trunnions 800a,b may be configured to receive and secure a beam or crossbeam 802. As will be appreciated below, the pair of trunnions 800a,b are also configured to secure the crossbeam 802 at a certain radial orientation thereby effecting the angular orientation of the kayaks 702a,b secured within the vessel assembly 701. In some embodiments, the pair of trunnions 800a,b are configured so that a user may adjust the radial orientation of the crossbeam 802 therein (i.e., rotate crossbeam 802) to a desired radial orientation, and then lock crossbeam 802 in such radial orientation so that the vessels such as kayaks 702a,b are at a desired angular orientation. The crossbeam 802 may be secured within the trunnions 800a,b at the desired radial orientation by any number of fasteners, including mechanical fasteners, friction lock fasteners, etc.

As illustrated, a second trunnion or mounting block 804a,b is disposed at each end of the crossbeam 802, where each of the mounting blocks 804a,b are configured to interconnect the cross-beam 802 to a telescoping shaft 806a,b. Each of the telescoping shafts 806a,b is configured to expand or retract (i.e., telescope) so as to accommodate different sized vessels such as the kayaks 702a,b. Accordingly, the telescoping shafts 806a,b may each include a sleeve portion 808a,b and a telescoping portion 810a,b, where each telescoping portion 810a,b is configured to extend from and retract into its respective sleeve portion 808a,b. Various locking mechanisms may be utilized to lock the telescoping portions 810a,b relative to their respective sleeve portions 808a,b. In the illustrated embodiment, the telescoping portions 810a,b each include a spring loaded pin that is configured to permit a user to selectively engage one of a plurality of holes formed into the sleeve portion 808a,b. It will be appreciated, however, that other locking mechanisms may be utilized as discussed above.

Each of the telescoping shafts 806a,b includes a top end 812 and an opposing bottom end 814. As illustrated, a first pair of laterally extending arms 816a,b are disposed at the top end 812 of each telescoping shaft 806a,b, and a second pair of laterally extending arms 818a,b are disposed at the bottom end 814 of each telescoping shaft 806a,b. The first pair of laterally extending arms 816a,b and the second pair of laterally extending arms 818a,b together define a channel or bed in which a piece of recreational equipment (e.g., a kayak or canoe) may be rested. Each of the first pair of laterally extending arms 816a,b and the second pair of laterally extending arms 818a,b may be laterally adjustable so as to accommodate canoes, kayaks, or other vessels of varying widths. In some embodiments, a bungee cord, strap or the like is utilized to further secure the vessel within the storage channel defined by the first and second pairs of laterally extending arms 816a,b, 818a. It will be appreciated that the equipment rack 700 may be utilized to store the pair of kayaks 702a,b illustrated in FIG. 8, a pair of bicycles 120a,b as illustrated in FIG. 1, or a bicycle and a kayak (not illustrated).

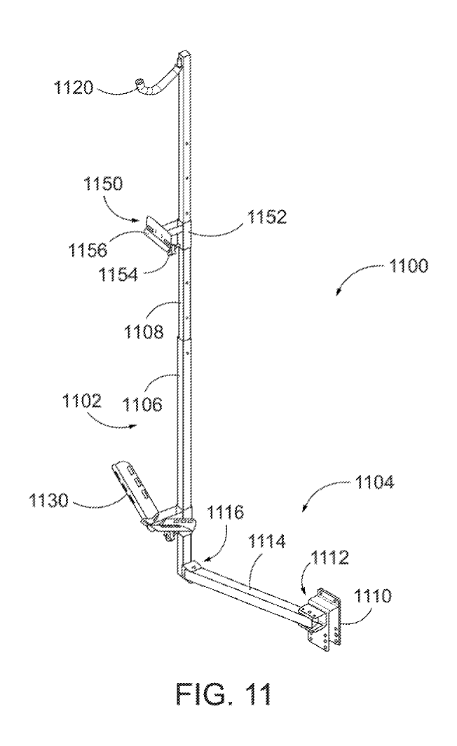

In even other embodiments, the equipment rack may articulate between a stowed position and un-stowed position where the user may more easily unload the equipment stored thereon. FIG. 11 illustrates an equipment rack 1100 that may articulate between various positions relative to a travel trailer, according to one or more embodiments. Here, the equipment rack 1100 includes a rack or rack portion 1102 and a mounting portion 1104. As illustrated, equipment (e.g., a bike, kayak, canoe, skis, etc.) may be attached to the rack portion 1102 and, in the illustrated embodiment, the rack portion 1102 includes a sleeve 1106 and a telescoping shaft 1108 extending therefrom; however, the rack portion 1102 may include other structures to which the equipment may be secured without departing form the present disclosure. It should be appreciated that, while the illustrated equipment rack 1100 is configured for a particular type of equipment (i.e., a bicycle), it may be differently configured as hereinbefore described to carry other equipment.

Also illustrated, the mounting portion 1104 includes a mounting bracket 1110, a mounting bracket joint 1112, an articulating arm 1114, and a rack joint 1116. Here, the mounting bracket joint 1112 is integrally attached to the mounting bracket 1110, the rack joint 1116 is integrally attached to the rack portion 1102, and the arm 1114 is arranged between the mounting bracket joint 1112 and the rack joint 1116 to articulate relative to both the mounting bracket joint 1112 and the rack joint 1116. In addition, the rack joint 1116 and the mounting bracket joint 1112 are provided such that the arm 1114 is rotatably attached to both the mounting bracket 1116 and the rack portion 1102. Here, for example, the mounting bracket joint 1112 and the rack joint 1116 each include a bolt or pin 1112′ and 11116′, respectively, and a first end 1114a is secured within the mounting bracket 1112 via the pin 1112′ and a second end 11114b is secured within the rack joint 1116 via the pin 1116′. Thus, the arm 1114 may pivot, rotate or swing about the pin 1112′ in a plane relative to the trailer, and the rack portion 1102 may pivot, rotate or swing about the pin 1116′ in the same plane relative to the arm 1114 and trailer. Here, the mounting bracket joint 1112 and the rack joint 1116 are revolute joints that provide one degree of freedom and rotation in a single axis; however, in other embodiments, they may include other joints as known in the art. Also shown in FIG. 11, the equipment rack 1100 includes a hook 1120 and a support member 1130 that are configured to secure the piece of recreational equipment, such as a bicycle, in a vertical orientation as described above. Either or both of the hook 1120 and/or the support member 1130 may be configured to slide or translate relative to the rack portion 1102 to vary the vertical orientation of the recreation equipment.

In one or more embodiments disclosed herein, the equipment rack 1100 may be configured to inhibit rotation of the bicycle wheel connected to the hook 1120. As illustrated in FIG. 11, for example, the equipment rack 1100 includes a wheel lock 1150 that inhibits rotation of a bicycle wheel that is secured to the hook 1120. Here, the wheel lock 1150 is provided with a sleeve 1152 such that it may translate along the rack portion 1102 to accommodate bicycle tires having various wheel diameters. The wheel lock 1150 may be configured to be secured at a certain location along the length of the rack portion 1102, for example, via a locking mechanism 1154 which is illustrated as a star knob, but, in other embodiments, may include various types of locking mechanisms as discussed above and/or as known in the art. Here, the wheel lock 1150 includes a wheel member 1156 that is configured to press against the side and/or bottom of the wheel to inhibit rotation of the same. For example, the wheel member 1156 may include a side part that is roughly parallel with the sidewall/rim of the bicycle wheel, and a lower part that is curved or angled engage the rubber tire of the wheel, and such curved or angled piece may be contoured to match a bicycle tire. In some embodiments, the wheel member 1156 may include a pad of material that further inhibits rotation of the wheel and may protect the wheel from abrasion or from being scratched, for example, a rubber pad. In even other embodiments, the wheel member 1156 may include protrusions that allow the wheel to be “snapped” into the wheel member 1156 and/or the wheel member 1156 may include straps or other elements that facilitate locking the wheel thereto.

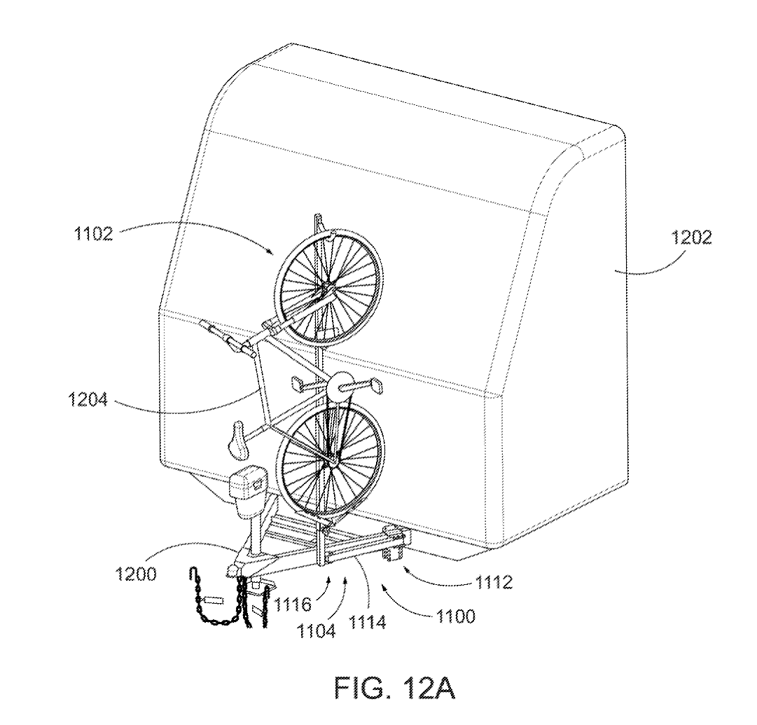

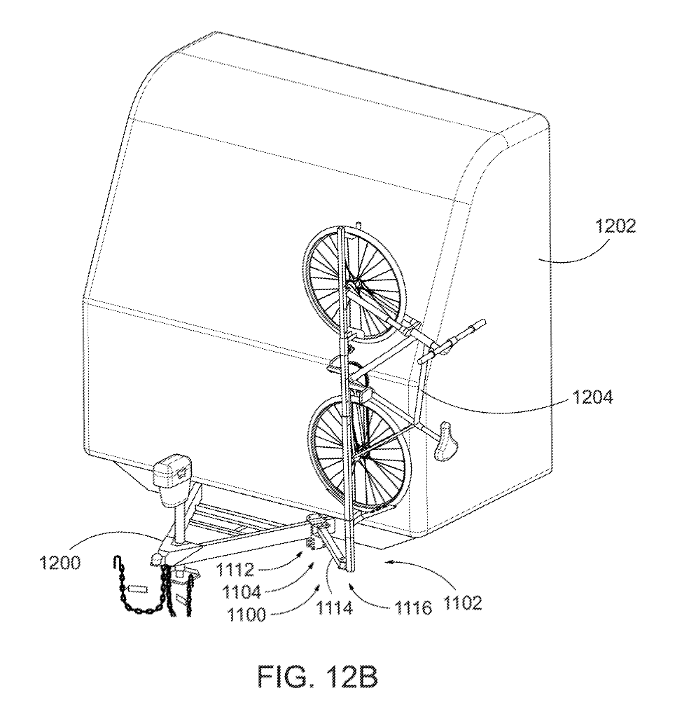

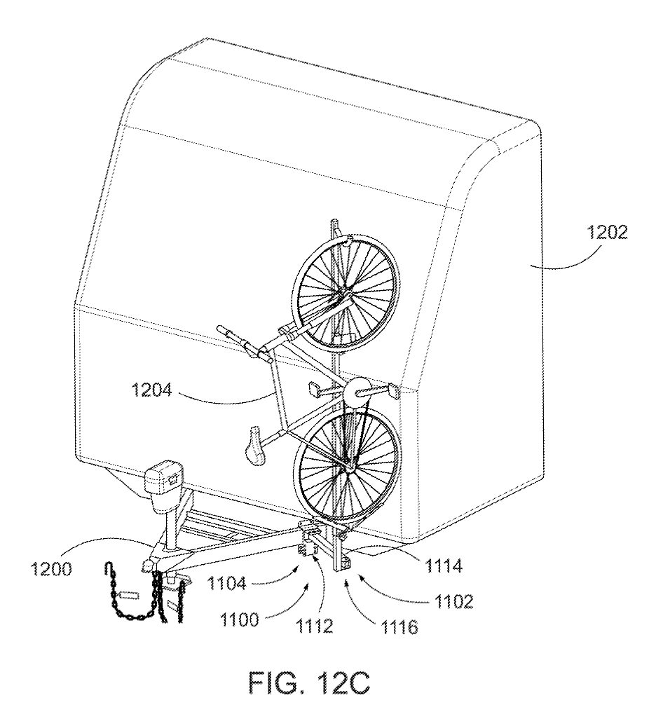

FIGS. 12A-12C illustrate the equipment rack 1100 when installed on a frame 1200 of a trailer 1202. More specifically, FIG. 12A illustrates the equipment rack 1100 holding a bicycle 1204 is in a stowed position where the arm 1114 is secured proximate to the frame 1200; and FIGS. 12B-12C illustrates the equipment rack 1100 when the arm 1114 is rotated outward from the frame 1200 and the rack portion 1102 is pivoted relative to the arm 1114 such that a user may install or uninstall a bicycle 1204 on or from the equipment rack 1100. While not illustrated, the equipment rack 1100 may further include a locking device to secure the arm 1114 at a certain angle relative to the frame 1200. For example, a latch or cord cold be used to secure the arm 1114 proximate to the frame 1200 when the equipment rack 1100 is in the stowed position as illustrated in FIG. 12A. In addition, the rack joint 1116 may also include a locking device to secure the rack portion 1102 in a desired angular orientation relative to the arm 1114. For example, the rack joint 1116 may include a series of pin holes that receive a locking pin, where the operator may secure the rack joint 1116 in the desired orientation by installing the lock pin in the pin holes that correspond with that orientation; however, other means may be utilized to lock the rack joint 1116 in the desired orientation. As mentioned above, however, it will be appreciated that this the equipment rack 1100 may be differently configured to hold other equipment (e.g., kayaks, canoes, boards, skis, etc.) and be similarly configured as described with reference to FIGS. 12A-12C to articulate and pivot relative to the trailer 1202 such that the equipment may be secured during transit and/or positioned outward therefrom to facilitate unmounting.

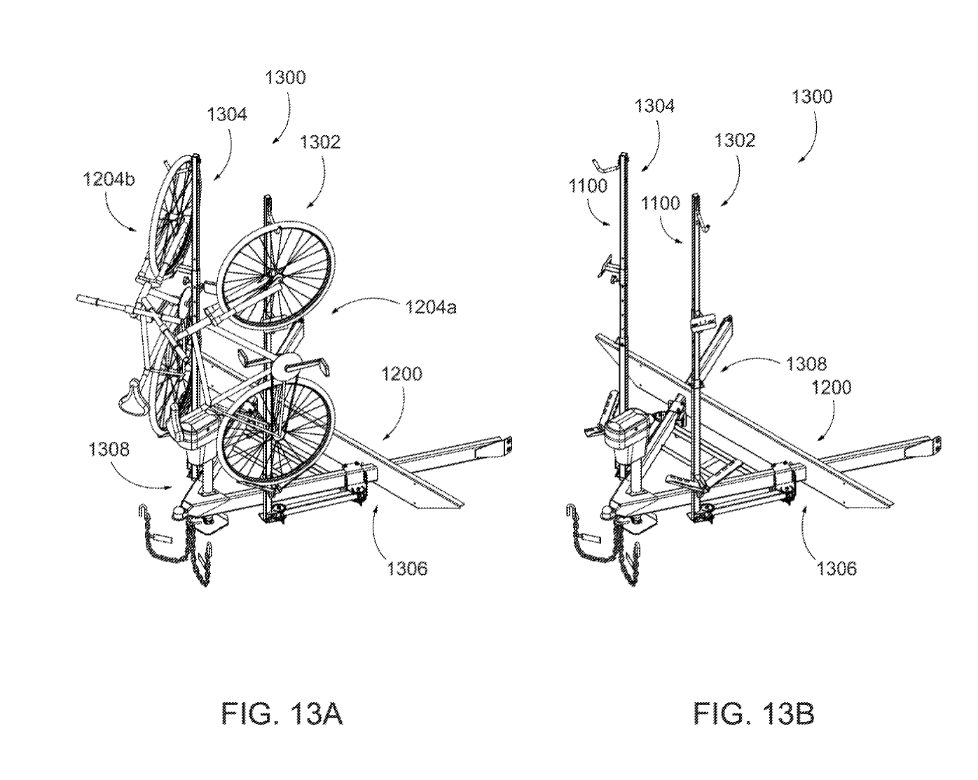

FIGS. 13A-13B illustrate an alternate embodiment of an equipment rack 1300 that is installed on opposing sides of a trailer frame 1200. Here, the equipment rack 1300 includes a pair of the equipment racks 1100 that are described with reference to FIGS. 11-12 and which are illustrated in FIGS. 13A-13B as first and second racks 1302,1304. The first rack 1302 is mounted on a corresponding first side 1306 of the trailer frame 1200 and the second rack 1304 is mounted on a corresponding second side 1308 of the trailer frame 1200. Also, in FIG. 13A, a pair of the bicycles 1204, illustrated as first and second bicycles 1204a,1204b, are secured within each of the first and second racks 1302,1304, respectively.

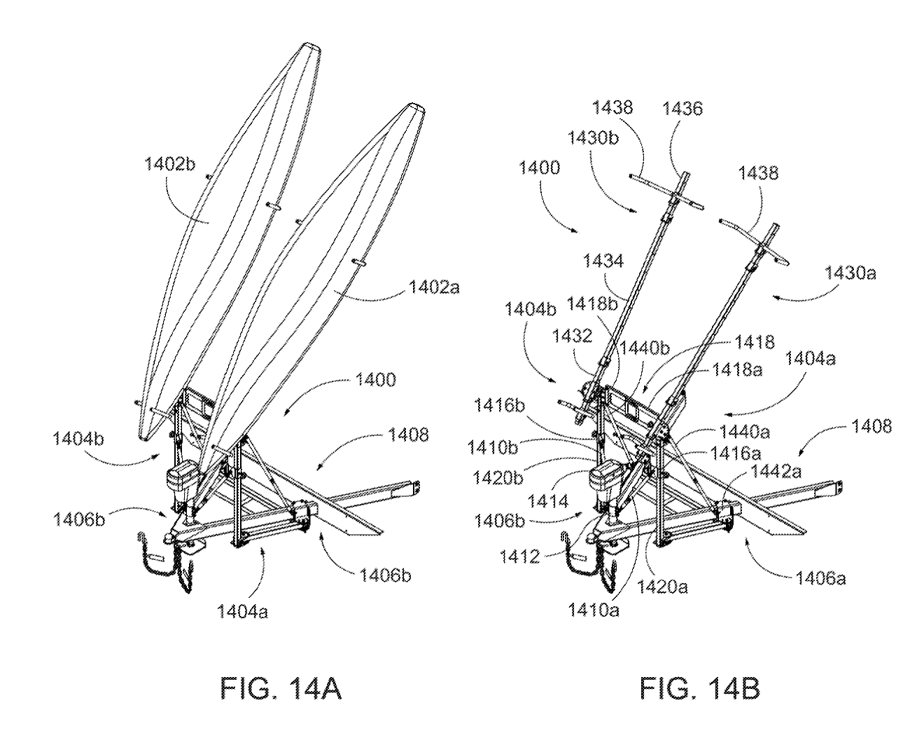

FIGS. 14A-14B illustrate an alternate embodiment of an equipment rack 1400 configured to store one or more kayaks or other vessels in various positions. FIG. 14A illustrates the equipment rack 1400 holding a pair of kayaks 1402a,1402b (which are not illustrated in FIG. 14B); however, the equipment rack 1400 may be differently configured to hold other pieces of equipment such as various vessels, canoes, boards, skis, etc. Here, the equipment rack 1400 includes pair of rack structures 1404a,1404b that are installed on opposing sides 1406a,1406b of a frame 1408 and that each secure a respective one of the pair of kayaks 1402a,1402b.

As discussed below, each of the rack structures 1404a,1404b may articulate (i.e., swing or rotate) relative to the trailer frame 1408. In FIGS. 14A-14B, for example, each of the rack structures 1404a,1404b is illustrated in its stowed position where it is positioned proximate to its corresponding side 1406a,1406b of the frame 1408. However, either or both of the rack structures 1404a,1404b may be articulated (i.e., swung or rotated) outward or away from the corresponding side 1406a,1406b of the frame 1408 such that it is located. In the illustrated embodiment, each rack structure 1404a,1404b of the equipment rack 1400 includes a strut 1410a,1410b that is configured to brace and secure the rack structure 1404a,1404b in their position relative to the frame 1408. In some embodiments, the struts 1410a,1410b are telescoping such that the rack structures 1404a,1404b may be positioned laterally away from the frame 1408, for example, in the un-stowed position or anywhere inbetween the stowed or un-stowed position. In some embodiments, the struts 1410a,1410b are pneumatic cylinders. Also, in some embodiments the struts 1410a,1410b are connected at each end thereof to move or revolve relative to the component to which it is connected. For example, each end of the struts 1410a,1410b be connected to the remainder of the rack structure 1404a,1404b via a ball joint or other joint that permits relative movement. Here, each struts 1410a,1410b is connected to a sleeve 1412 positioned proximate to a control console at a front jack 1414 thereof, with the struts 1410a,1410b each being moveable relative to the sleeve 1412. In the illustrated embodiment, at least one of the opposing ends of either or both of the struts 1410a,1410b includes a ball (or socket) that engages a mating socket (or ball) of the sleeve 1412 such that the struts 1410a,1410b may rotate relative to the sleeve 1412. In another embodiment, the ends of the struts 1410a,1410b are each pinned to the sleeve 1412 to rotate relative to the sleeve 1412 in a single plane, but in other embodiments the strut 1410a,1410b may be differently connected to rotate relative to the sleeve 1412 in one or more planes. Similarly, each of the struts 1410a,1410b may be connected to its respective rack structure 1404a,1404b via a respective mount 1416a,1416b, and either or both of the strut 1410a,1410b may be connected to its respective mount 1416a,1416b in a similar manner as they are connected to the sleeve 1412. In the illustrated embodiment, for example, an end of either or both of the struts 1410a,1410b includes a ball (or socket) that engages a mating socket (or ball) of the respective mount 1416a,1416b such that the struts 1410a,1410b may rotate relative to the mounts 1416a,1416b. In another example, either or both of the struts 1410a,1410b is pinned to its corresponding mount 1416a,1416b, but may be differently connected without departing from the present disclosure. The struts 1410a,1410b may include locking mechanisms that permit them to be selectively locked in at a desirable length. Also in the illustrated embodiment, the mount 1416a,1416b are each configured as sleeve structures that may be positioned at various locations along the length of a vertical support 1420a,1420b, and may include a locking mechanism to secure the mount 1416a,1416b at a desired location on the respective vertical support 1420a,1420b. In some embodiments, the vertical supports 1420a,1420b may be configured as telescoping members to vary the height at which equipment is supported within the equipment rack 1400.

In the illustrated embodiment, the equipment rack 1400 includes a brace 1418 that connects the rack structures 1404a,1404b together. Here, the brace 1418 is a cross bar structure that secures upper ends of the vertical supports 1420a,1420b together, but in other embodiments the brace 1418 is connected to the vertical supports 1420a,1420b at different vertical locations thereon other than as illustrated. The brace 1418 may be utilized to minimize or ensure that the rack structures 1404a,1404b do not deflect due to the weight of the equipment held therein, and may also ensure that the rack structures 1404a,1404b don't deflect during movement. Moreover, the brace 1418 may be utilized retain the rack structures 1404a,1404b together in the stowed position where they are each secured proximate to the frame 1408 and unable to unintentionally rotate outward therefrom into the un-stowed position. In the illustrated embodiment, the brace 1418 includes a first half 1418a and a second half 1418b that are configured to slide relative to each other, but also configured to be secured (e.g., via a threaded fastener) at a desired width that fixes the rack structures 1404a,1404b relative to each. In this embodiment, the rack structures 1404a,1404b may articulate outward of the frame 1408 into the un-stowed position when the first and second halves 1418a,1418b are permitted to slide relative to each other, but the rack structures 1404a,1404b are fixed relative to each other when the first and second halves 1418a,1418b are secured relative to each such that it may not expand in width.

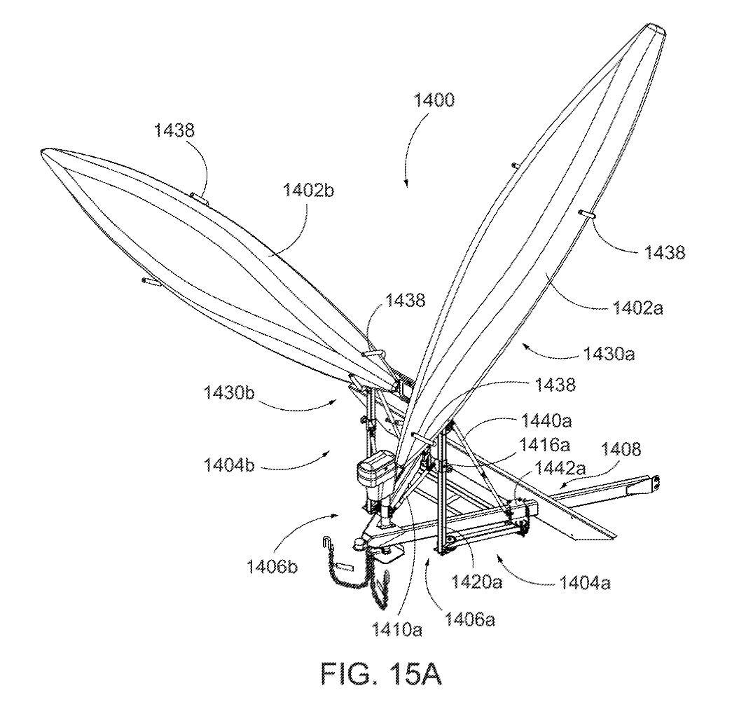

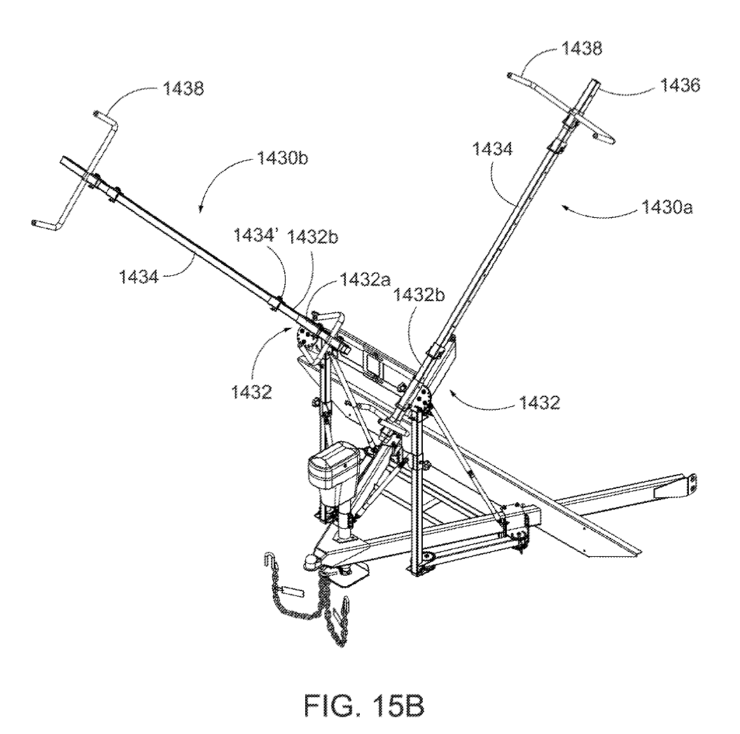

The equipment rack 1400 is configured to hold equipment such as the kayaks 1402a,1402b. In the illustrated embodiment, the rack structures 1404a,1404b each include an equipment bed 1430a,1430b, respectively. Here, the equipment beds 1430a,1430b each include a base 1432 and an extension member 1434, where the base 1432 is configured as a sleeve within which the extension member 1434 may slide relative to the base 1432, which will allow a user to vary the location/orientation at which the equipment is stored within the equipment bed 1430a,1430b. The base 1432 may be a unitary member or may comprise separate parts that may be configured to move relative to each other. Here, for example, the base 1432 includes a housing 1432a and a shaft 1432b that is configured to slide within the 1432a and be selectively locked to vary the position of the equipment beds 1430a,1430b. In addition, a locking mechanism may be provided to secure the extension member 1434 at a certain position relative to the base 1432 and, in the illustrated embodiment, a locking mechanism 1434′ is provided to secure the extension member 1432 relative to the shaft 1432b of the base 1432 such that the extension member 1432 may telescope within the shaft 1432b and be secured in a desirable position to accommodate the equipment. Moreover, the equipment bed 1430a,1430b may include one or more second extension members 1436 that telescope from either or both ends of the extension member 1434, such that the overall length of the equipment bed 1430a,1430b may be varied to accommodate different sized equipment (e.g., to accommodate kayaks 1402a,1402b having various lengths). As described below the base 1432 and/or the base housing 1432a of either or each equipment bed 1430a,1430b may be configured to laterally rotate from the generally horizontal or up-right position (as illustrated in FIGS. 14A-14B) outward towards the sides 1406a,1406b of the frame 1408 into a lowered position (as illustrated with respect to the equipment bed 1430b in FIGS. 15A-15B).

Also, the equipment bed 1430a,1430b may include equipment retainers 1438 at opposing ends of the equipment bed 1430a,1430b, that are configured as arms that laterally extend about the sides of the equipment to retain it side to side. The arms of the equipment retainers 1438 may be fixed at certain widths and replaceable to accommodate different width equipment, or may be laterally adjustable to accommodate equipment of different widths. In some embodiments, the retainers 1438 are made from a compliant material that may be manipulated and/or bent around the equipment to further secure the equipment. In such embodiments, the retainers 1438 may be secured together, for example, via a bungee cord, tether, etc. For example, the retainers 1438 may be of rubber or plastic that may be wrapped around the sides of the kayaks 1402a,1402b and possibly secured together at their ends or tied together at their ends.

Also in the illustrated embodiment, each of each the rack structures 1404a,1404b is further braced or secured from deflecting via a second strut 1440a,1440b. Here, each strut 1440a,1440b is connected via a ball joint to an upper end of the vertical supports 1420a,1420 in a similar manner as described with reference to the struts 1410a,1410b being connected relative to the sleeve 1412 and/or the mounts 1416a,1416b; however, either or both of the struts 1440a,1440b may be differently connected as disclosed herein, for example, via a pin. Also, each strut 1440a,1440b may be connected via a ball and joint or a pin to its respective side 1406a,1406b of the frame 1408 as previously described, for example, at a mounting bracket 1442a,1442b (obscured from view). Here, the struts 1440a,1440b are each connected to the respective one of the mounting brackets 1442a,1442b via a ball joint, but may be differently connected as disclosed herein. In even other embodiments, either or both of the struts 1440a,1440b are fixed to either or both of the vertical supports 1420a,1420b and/or mounting brackets 1442a,1442b to inhibit relative rotation. In some embodiments, the struts 1440a,1440b are telescoping and, in these or other embodiments, the struts 1410a,1410b are pneumatic cylinders.

Also in the illustrated embodiment, the equipment beds 1430a,1430b are configured to hold the equipment (e.g., the kayaks 1402a,1402b) in various positions such as, for example, an upright position where the equipment is stowed and out of the way and an lowered position where the equipment is rotated into a user accessible location. In the illustrated example, a user may manipulate either or both of the rack structures 1404a,1404b to rotate the respective equipment beds 1430a,1430b between the upright and lowered position, where he or she may more easily access the equipment when rotated into the lowered position. FIGS. 15A-15B illustrate the equipment rack 1400 wherein the equipment bed 1430b of one of the rack structures 1404b has been rotated into the lowered position and wherein the other equipment bed 1430a of the other one of the rack structures 1404a remains in the upright position. As illustrated, the base 1432 of the equipment beds 1430a,1430b may be coupled to the vertical supports 1420a,1420b so that the bases 1432 rotate in a plane relative to their respective vertical supports 1420a,1420b. In addition, a retainer 1450 may be provided on the bases for securing the equipment bed 1430a,1430b in either the up-right or lowered position, or in any position between the up-right and lowered positions. In some embodiments, the retainer 1450 includes a series of holes though which a pin or fastener may be inserted to lock the equipment bed 1430a,1430b in position.

Thus, the equipment rack 1400 may rotate either or both rack structure 1404a,1404b with equipment stored thereon from an un-stowed position where it is rotated away from the frame 1408 into a stowed position where it is secured proximate to the frame 1408 as illustrated in FIG. 14A, and then secured in such stowed or un-stowed positions. In some of these embodiments, the rack structures 1404a,1404b may be rotated into intermediate positions between the stowed and un-stowed positions, and secured in such intermediate positions.

In addition, the equipment beds 1430a,1430b of either or both of the rack structures 1404a,1404b may be rotated from an up-right position into a lowered position where the equipment is more easily accessible and where a user may more easily access the upper retainer 1436, as illustrated with respect the equipment bed 1430b of the rack structure 1404b in FIGS. 15A-15B. In some of these embodiments, the equipment beds 1430a,1430b may be rotated into intermediate positions between the up-right and lowered positions, and then secured in such intermediate positions. Users may find it desirable to articulate the rack structures 1404a,1404b into the stowed position and/or rotate the equipment beds 1430a,1430b into the up-right position as described herein when traveling, when in confined spaces, or whenever it may be desirable for the equipment to be held out of away; and, when it is desirable to access the equipment, the equipment rack 1400 may be manipulated to swing the rack structures 1404a,1404b into their extended positions and/or rotate the equipment beds 1430a,1430b into the lowered positions to make the equipment more easily accessible for dismounting from the equipment rack 1400. Moreover, the rack structures 1404a,1404b may be articulated into various positions between the stowed and un-stowed positions (and secured therein) and/or the equipment beds 1430a,1430b may be rotated into various intermediate positions between the up-right and lowered positions (and secured therein) as needed. In even other embodiments, the equipment rack 1400 may be provided with various assist systems that permit the equipment beds 1430a,1430b to be rotated in a controlled fashion. For example, various pneumatic cylinders or devices may be utilized to ensure the equipment beds 1430a,1430 rotate laterally from the up-right position to the lowered position in a controlled fashion.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, top, bottom, and the like are used in relation to the illustrative embodiments as they are depicted in the figures, the upward direction being toward the top of the corresponding figure and the downward direction being toward the bottom of the corresponding figure.

What is claimed is:

1. An equipment rack for a trailer that includes a trailer frame, the equipment rack comprising:
at least one substantially vertical member having a top end and a bottom end;
a wheel securing means disposed proximate to the top end;
a wheel support means disposed proximate to the bottom end; and
a mounting portion configured to connect the vertical member to the trailer frame.

2. The equipment rack of claim 1, wherein the vertical member articulates relative to the trailer frame between a first position where the vertical member is proximate to the trailer frame and a second position where the vertical member is rotated away from the trailer frame.

3. The equipment rack of claim 1, wherein the mounting portion includes an articulating arm that is rotatably attached to the vertical member and rotatably attached to the trailer frame.

4. The equipment rack of claim 3, wherein the articulating arm is rotatably attached to the vertical member via a first joint.

5. The equipment rack of claim 3, wherein the articulating arm is rotatably attached the trailer frame via a second joint.

6. The equipment rack of claim 3, wherein the mounting portion includes a mounting bracket that is secured to the trailer frame, and the articulating arm is rotatably attached to the mounting bracket.

7. The equipment rack of claim 1, wherein the mounting portion is a bracket that secures the bottom end of the vertical member to the trailer frame.

8. The equipment rack of claim 1, wherein the securing means includes a hook.

9. The equipment rack of claim 8, wherein the hook is configured to translate along the vertical member.

10. The equipment rack of claim 8, wherein the wheel hook is releasably secured to the vertical member proximate to the top end thereof.

11. The equipment rack of claim 1, wherein the securing means is connected to the top end of the vertical member via a sleeve that is configured to vertically translate along the vertical member.

12. The equipment rack of claim 1, wherein the wheel support means includes channel member.

13. The equipment rack of claim 12, wherein the channel member is configured to translate along the vertical member.

14. The equipment rack of claim 1, wherein the wheel support means is connected to the bottom end of the vertical member via a sleeve that is configured to vertically translate along the vertical member.

15. The equipment rack of claim 1, wherein the vertical member comprises a sleeve portion and a telescoping portion that is configured to telescope therein.

16. The equipment rack of claim 15, wherein the telescoping portion is selectively locked within the sleeve portion with a locking mechanism.

17. The equipment rack of claim 16, wherein the locking mechanism is selected from the group consisting of a spring loaded pin and hole arrangement, a pawl and detent system, a friction locking system, or any combination thereof.

18. The equipment rack of claim 1, wherein there are two vertical members, and the equipment rack further comprises a crossbar that interconnects the tops ends of the vertical members.

19. The equipment rack of claim 1, further comprising a trunnion disposed on the at least one vertical member and configured to translate relative thereto;
a beam having a pair of ends and extending through a passageway of the trunnion;
a telescoping member disposed at each of the pair of ends of the beam, the telescoping member further comprising a first pair of arms laterally extending from a first end thereof and a second pair of arms laterally extending from a second end thereof, wherein the first pair of arms and the second pair of arms define a bed for receiving recreational equipment.

20. The equipment rack of claim 19, wherein the trunnion is configured to permit selective rotation of the beam within the passageway.
